(19) United States
(12) Patent Application Publication
(10) Pub. No.: US 2003/0142074 A1
(43) Pub. Date: Jul. 31, 2003

(54) Control device for manual hold by either hand, disposable on either side, on the tilt

(76) Inventor: Tai-Her Yang, Dzan-Hwa (TW)

Correspondence Address: RABIN & BERDO, P.C., Suite 500, 1101 14th Street, N.W., Washington, DC, 20005, US

(21) Appl. No.: 10/128,358

(22) Filed: Apr. 24, 2002

Related U.S. Application Data
(63) Continuation-in-part of application No. 10/055,946, filed on Jan. 28, 2002.

(51) Int. Cl. G09G 5/08

(52) U.S. Cl. 345/161

(57) ABSTRACT

Control Device for Manual Hold by Either Hand, Disposable on Either Side, on the Tilt, in a shell casing of which the cross section is nearly trapezoidal, with the larger hypotenuse that is defined by two non-parallel inclusion angles accounting for a laydown face on a relatively right hand side or relatively left hand side, and with the two remaining sides or the larger one of these, of the shell casing defined nearly trapezoidal across its section accommodating the control interface for manual operation, by the hand hold, steadily, using either right hand or left hand as appropriate, to the device is added an optional feature in the form of an adjunct ring snap fixture serving to prevent the present control device from dropping incidentally once the fingertip is withdrawn.

### CROSS-REFERENCES TO RELATED APPLICATIONS

This application is a Continuation-In-Part of my patent Application, Ser. No. 10/055,946, filed Jan. 28, 2002.

### BACKGROUND OF THE INVENTION

(a) Field of the Invention

Design of Control Device for Manual Hold by Either Hand, disposable on either side, on the tilt, comprising a shell of which the cross section resembles a trapezoid, whereof a larger hypotenuse that opposes the angle formed by two non-parallel constitutes a laydown side, right or left; with both of the remaining sides, or the larger one of them, of said shell, forming a control interface meant for fingertip manipulation, so as to facilitate manual control with the left hand or with the right hand once said control interface is installed on the left side, or alternatively, on the right side. To the Device is optionally furnished an adjunct ring snap serving to prevent the subject Control Device for Manual Hold by Either Hand, disposable on the Tilt, on Either Side, from dropping incidentally once the fingertip is withdrawn.

(b) Description of the Prior Art

Trackball devices, available on the marketplace as of today, are made specifically for use with just one hand only, say, left hand to the preclusion of right hand, or contrarily, with right hand to the preclusion of left hand, and that means certain inconvenience involved in the production as well as marketing management.

### SUMMARY OF THE INVENTION

The primary object of the invention is to provide the design of a typically electrically powered Control Device for Manual Hold by Either Hand, Disposable on Either Side, on the Tilt, featuring a shell structure which resembles a trapezoid on the cross section and suitably arranged control interface so that equal accommodation is made as regards laying to the left hand side or to the right hand side in reference to a central point, or still holding for manual control;

Realization of the invention in another embodiment is to further process the afore-mentioned shell featuring a trapezoidal cross-section into a grip configuration, complete with a plurality of protective finger ring to facilitate manual control, or setting on either side of a reference table front whereby manual control by either hand, right or left, is made possible all at once;

A further realization of the invention is to further process the afore-mentioned shell featuring a trapezoidal cross section into a grip configuration, complete with a single finger ring, a protective means to facilitate manual control, or setting on either side of a reference table front whereby manual control by either hand, right or left, is made possible all at once;

As a further variant, the invention may be embodied such that the afore-mentioned shell structure comprising a trapezoidal cross section is processed into a bare grip clear and free of any protective ring to facilitate manual control, or setting on either side of a reference table front whereby manual control by either hand, right or left, is made possible all at once.

### BRIEF DESCRIPTION OF THE DRAWINGS

FIG. 1 is a three-dimensional perspective of the invention executed with a multiple wound protective finger ring;

FIG. 2 is a side view of the illustration pursuant to FIG. 1;

FIG. 3 is a rear view of the illustration pursuant to FIG. 1;

FIG. 4 is an illustration of actuation of the invention in a manual holding mode;

FIG. 5 is an illustration of several layouts of the invention respecting two hypotenuse sides in the making;

FIG. 6 illustrates the invention as installed onto the left side of a reference table front;

FIG. 7 illustrates the invention as installed onto the right side of a reference table front;

FIG. 8 is a top view of the invention being installed for leftward operation;

FIG. 9 is a top view of the invention being installed for rightward operation;

FIG. 10 is a three-dimensional perspective of the invention executed with protection of just one finger for operation;

FIG. 11 is a side view of the illustration pursuant to FIG. 10;

FIG. 12 is a rear view of the illustration pursuant to FIG. 10;

FIG. 13 is an illustration of the invention with manual operation in action;

FIG. 14 illustrates the plurality of laying facades by the co-action of two hypotenuses, pursuant to the invention;

FIG. 15 illustrates the invention as established to the left side of a reference table front;

FIG. 16 illustrates the invention as established to the right side of a reference table front;

FIG. 17 is a top view of the invention being operated leftward in practice;

FIG. 18 is a top view of the invention being operated rightward in practice;

FIG. 19 is a three-dimensional perspective of the invention executed free of any protective finger ring;

FIG. 20 is a side view of the illustration pursuant to FIG. 19;

FIG. 21 is rear view of the illustration pursuant to FIG. 19;

FIG. 22 is an illustration of the invention with the manual operation in action;

FIG. 23 is an illustration of the plurality of layout composed of two hypotenuses according to the invention;

FIG. 24 is an illustration of the invention lying to the left side of a reference table front;

FIG. 25 is an illustration of the invention lying to the right side of a reference table front;

FIG. 26 is a top view of the invention operated leftward; and, FIG. 27 is a top view of the invention operated in a rightward orientation;

FIG. 28 illustrates, on a three-dimensional setting, an adjunct snap ring that is incorporated to the embodiment represented in any of figures denoted FIG. 1 through FIG. 9;

FIG. 29 illustrates, on a three-dimensional setting, an adjunct snap ring that is incorporated to the embodiment represented in any of figures denoted FIG. 10 through FIG. 18;

FIG. 30 illustrates, in a three-dimensional setting, an adjunct snap ring that is incorporated to the embodiment represented in any of figures denoted FIG. 19 through FIG. 27; and,

FIG. 31 illustrates a side view that is true of the illustrations given in FIG. 28 through FIG. 30.

### DETAILED DESCRIPTION OF THE PREFERRED EMBODIMENTS

What follows is a detailed description of the invention in terms of its structural characteristics, other functional merits and objects in reference to the accompanying drawings;

More specifically, the invention Control Device for Manual Hold by Either Hand, Disposable on Either Side, on the Tilt, on the base of a shell framework of which the cross section resembles a trapezoid, comprises essentially:

a shell framework accommodating analogous circuits, power supply, manually controlled interfacing and display interfacing;

handle in the form of a grip;

optionally provided annular protection means, surrounding the exteriority of singly formed or plurally formed finger, in single hole or multiple hole executions, once the grip is held manually; the annular protection being executed integral with the grip and the shell casing, or else by combination or still, removably; featuring a trapezoidal cross section, with the larger hypotenuse that is included by the angle formed by the non-parallel sides constituting the laydown side rightwards or leftwards of a reference table front, and the two remaining sides or the larger one of these, of the shell casing defined with a cross-section accommodating a control interface meant for digital operation, say, by the right hand or left hand, as same is installed on the right-hand side or left-hand side of the reference table front;

Again, by setting said shell casing defined with a nearly trapezoidal cross-section on a surface, with the larger hypotenuse that is included by two non-parallel laterals by which an angle is formed serving as the laydown side rightwards or leftwards of a reference table front, a flat surface spread, and the two remaining sides or the larger one of these, of the shell case as aforementioned defined with a cross section accommodating a control interface meant for digital operation, control for operation with the right hand or left hand is made depending on the location of the shell casing, on the right hand side or left hand side of the operator positioned in line with the reference point.

By the teachings given in the foregoing, the invention may be embodied in various geometric configuration to serve the same purpose, what is quoted below is a few embodiments realizable of the subject Control Device where of the shell casing is defined with a nearly trapezoidal cross section on a surface, with the larger hypotenuse that is included by two non-parallel laterals by which two angles of inclusion are formed, serving as the laydown side rightwards or leftwards of a reference point on a bench, and the two remaining sides or the larger one of them, of the shell casing as aforementioned defined with a cross section accommodating a control interface meant for digital operation, control for operation with the right hand or left hand is made depending upon the location of the shell casing, on the right hand side or left hand side of the operator positioned in line with the reference point.

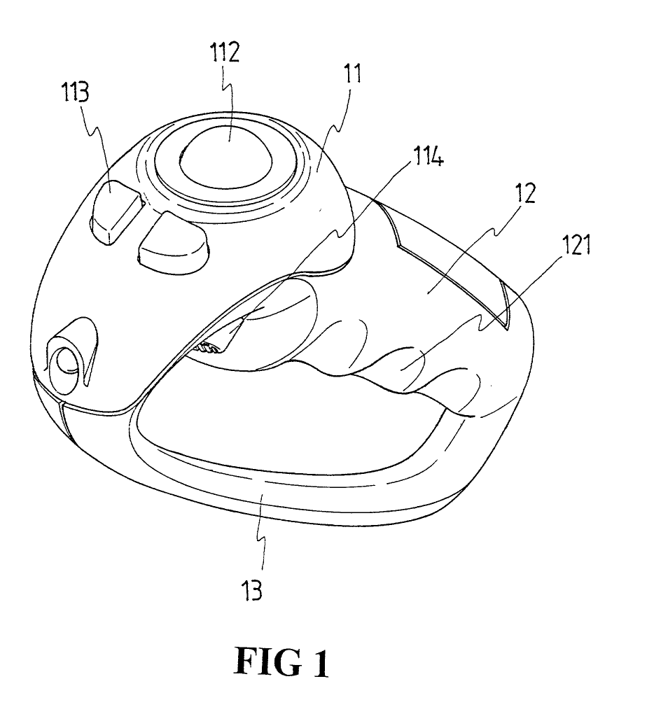

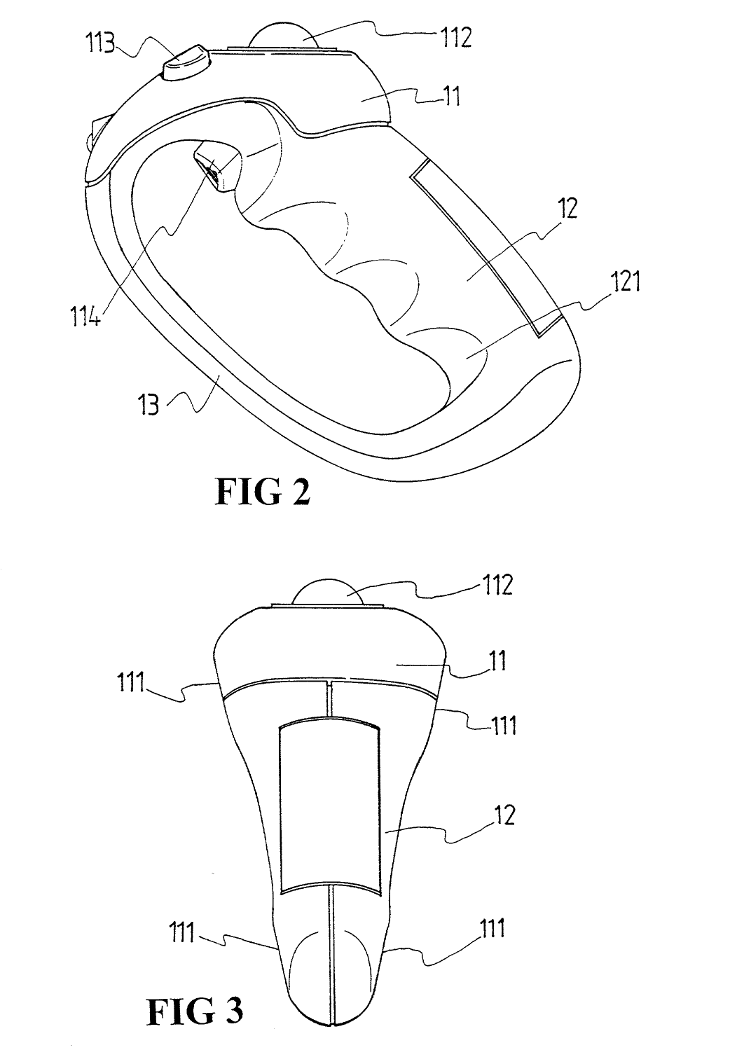

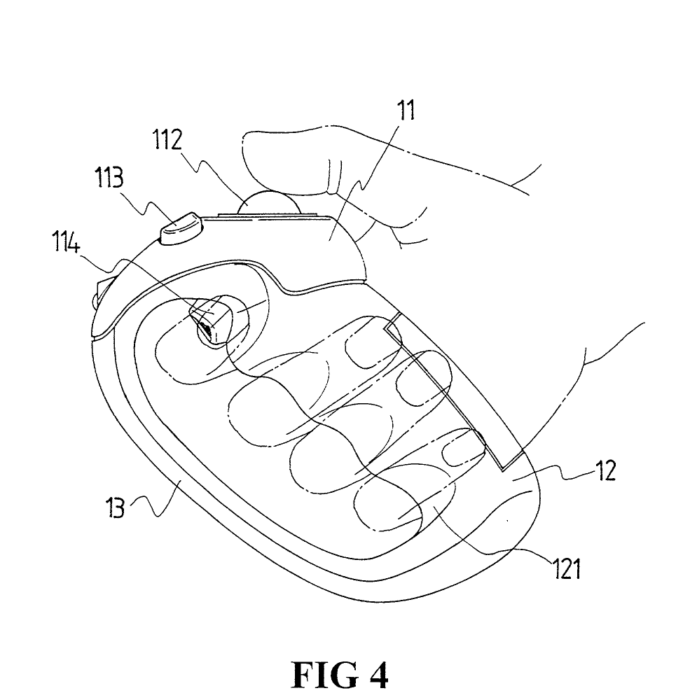

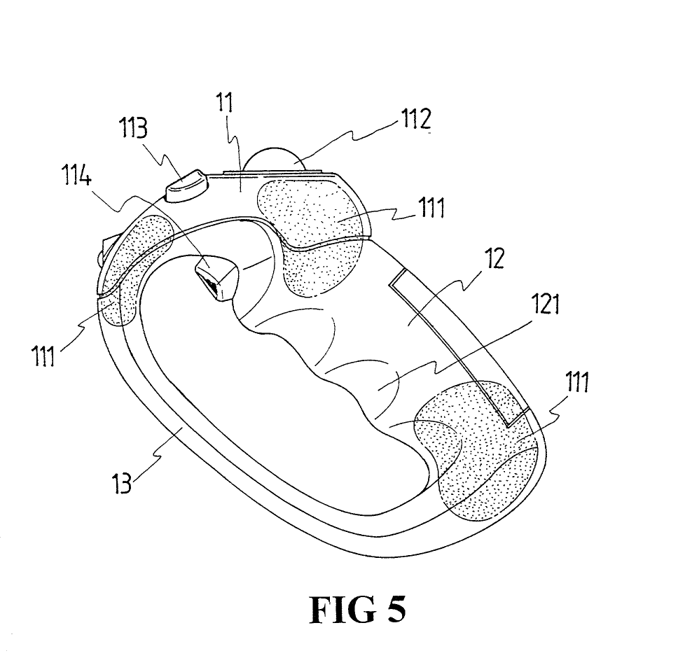

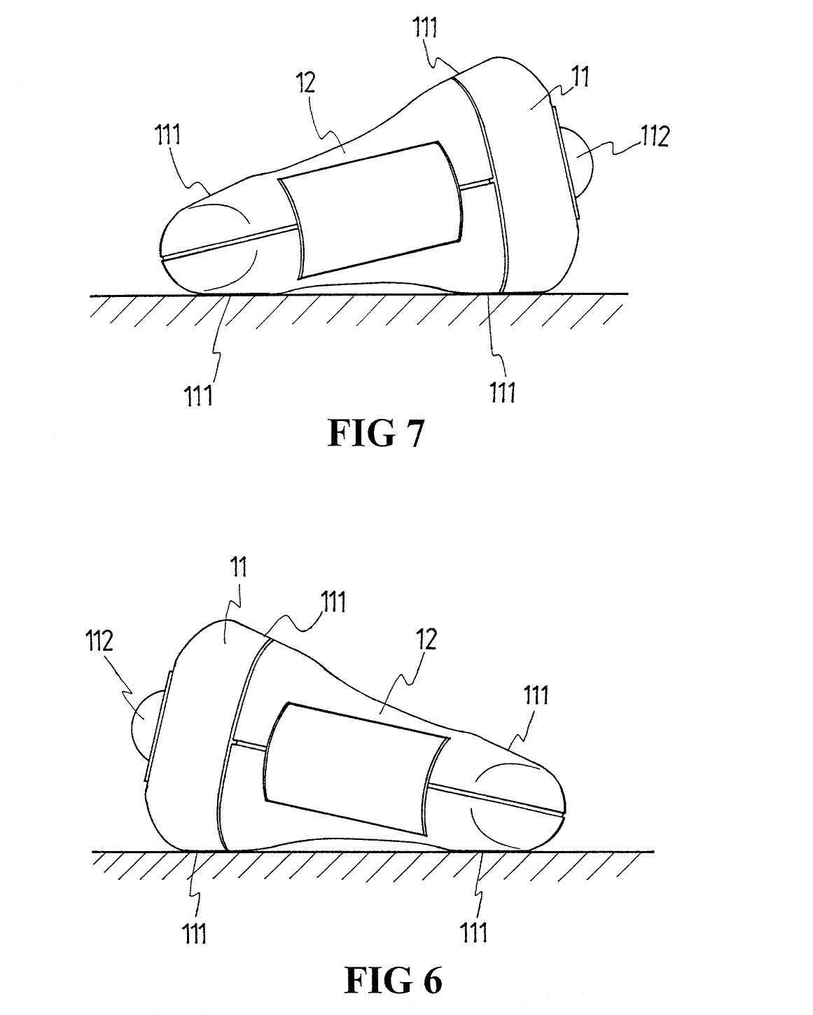

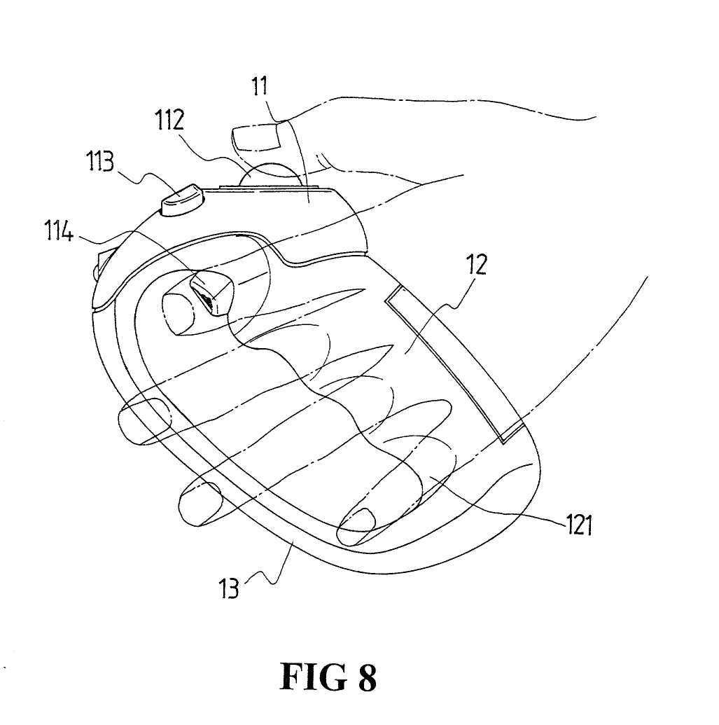

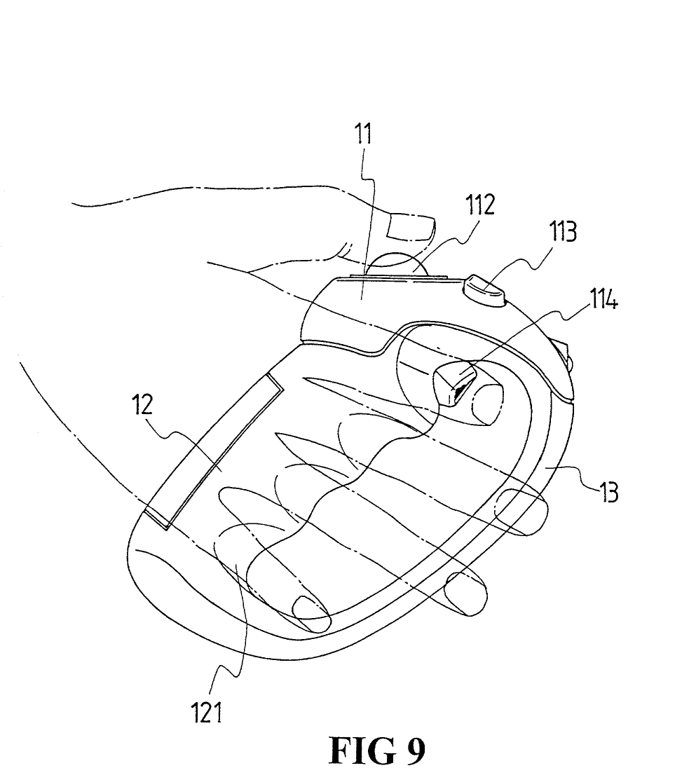

Referring to FIG. 1 and FIG. 2, a three-dimensional illustration of the invention executed with a multiple wound protective finger ring, and the same seen in a side view, it is seen that the same comprises shell casing 11 into which are housed relevant circuits, power supply and manual controlled interfacings 111, 112, 113, and display interface, underneath the shell casing 11 is mounted a grip 12 for manual hold, ahead of the grip 12 are furnished a plurality of digital indentations 121, and additionally where required, a digital protection means 13 around the multiple finger formation, so that once manual holding is made of the grip 12, same may be surrounded outside of the multiple finger formation through multiple holding array see illustration of FIG. 4), the digital protection 13, the grip 12 and the shell casing 11 being executed integral, or for combination assemblage, or still, removably assembled; a salient feature of the invention is that the terminal edge of the shell casing 11 is treated nearly trapezoidal in the cross section (see illustration of FIG. 3), and that a larger hypotenuse defined by two inclusion angles out of parallelism on either side is made to account for a flat laydown surface 111, on the right hand side or on the left hand side, or alternatively, these be constituted of laying points of chosen deployment or still of yet smaller laying faces, such as is illustrated in FIG. 5, further, on the two remaining sides or on the larger one of these, of the shell casing 11 that is defined with a trapezoidal cross-section is installed where appropriate, control interfaces 112, 113, 114 so that once the device altogether is laid relatively righthanded or lefthanded of a table front, such as is illustrated in FIG. 6 and FIG. 7, it will make handy control by the right hand or left hand respectively, a top view of the device in service by the lefthand side is given in FIG. 8, a top view of the device in service by the righthand side is given in FIG. 9.

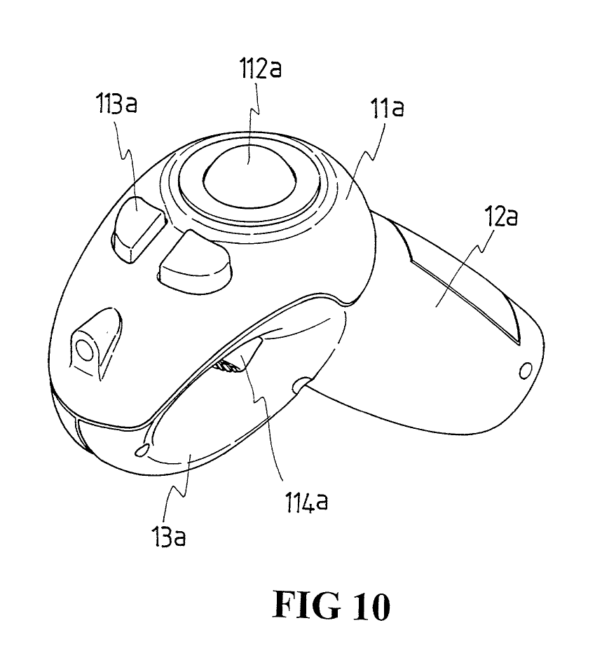

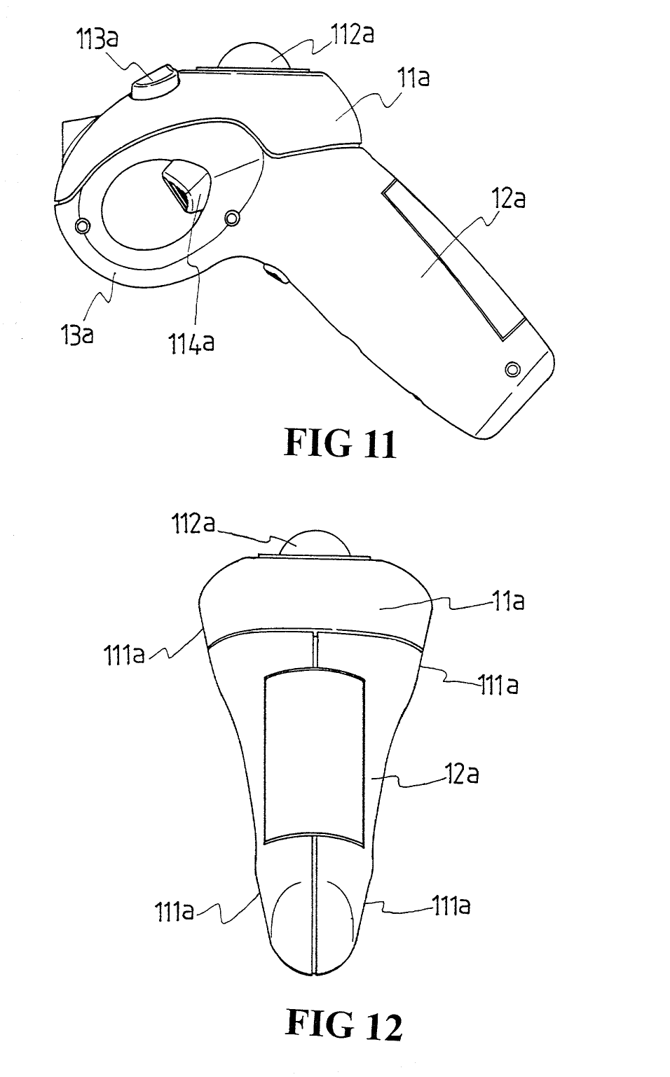

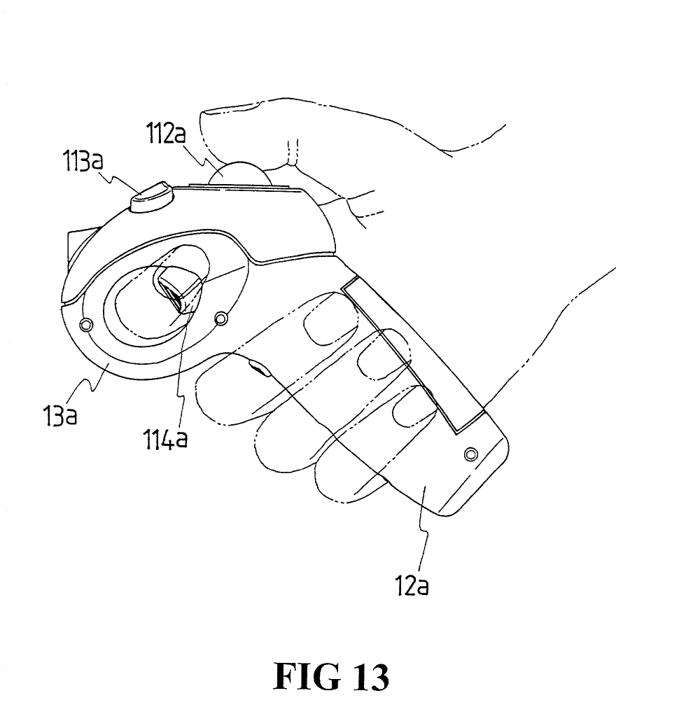

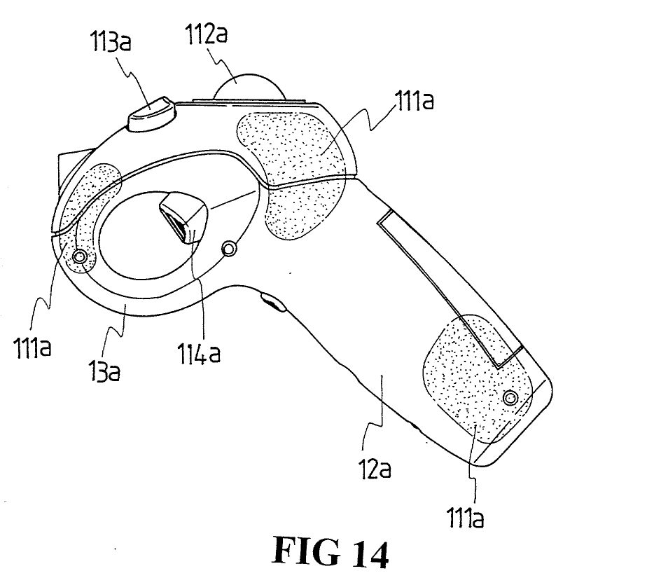

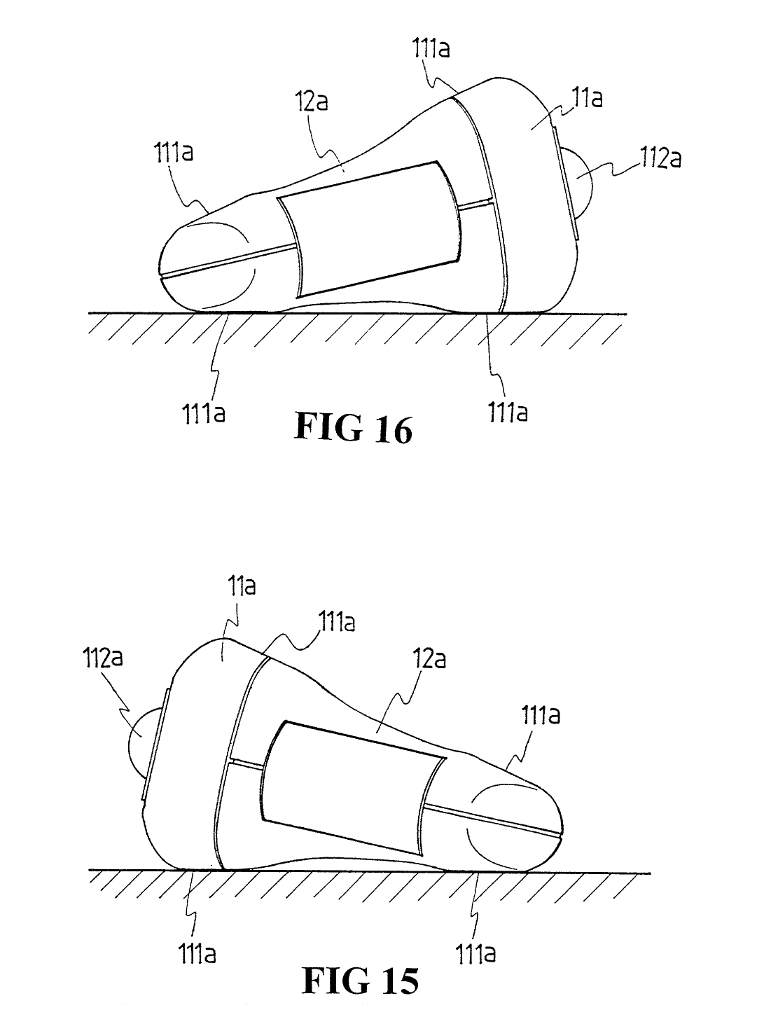

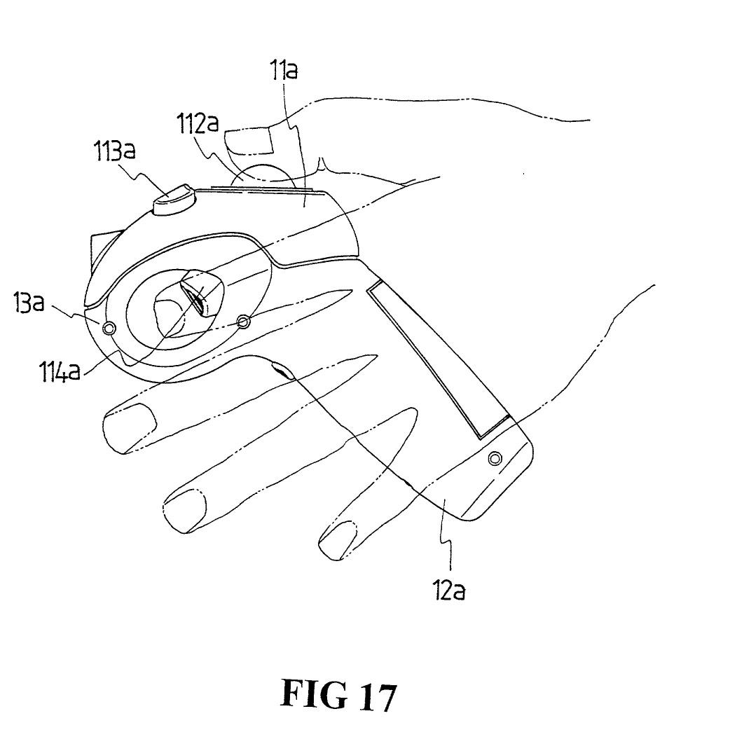

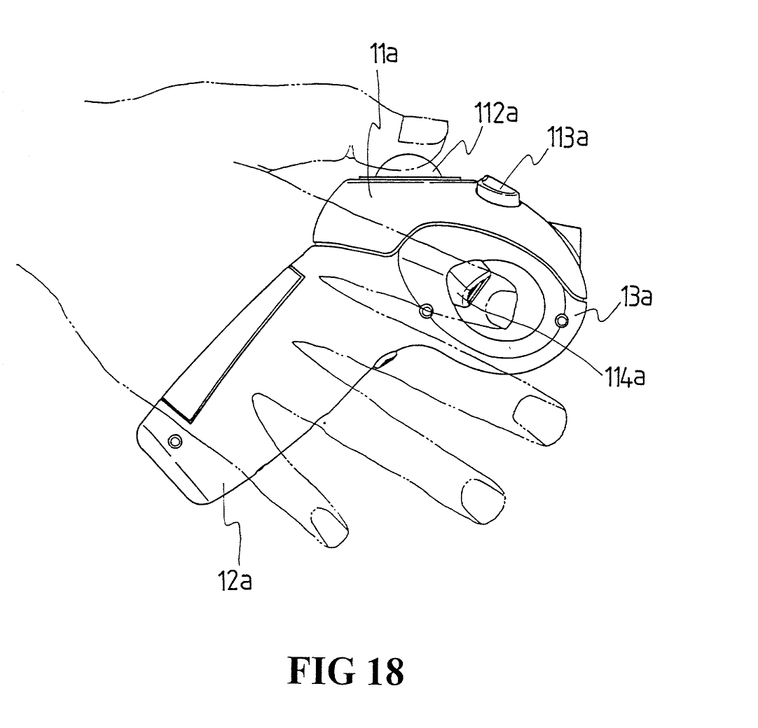

With reference to FIG. 10, FIG. 11, covering the invention in an embodiment with protection of just one finger for operation in a three-dimensional setting, and the same in a side view, it will be appreciated that the shell casing 11a houses relevant circuits, power supply and manually controlled interfaces 112a, 113a, 114a and display interface, underneath the shell casing 11a is installed a grip 12a for manual hold, ahead of the shell casing 11a is optionally furnished a finger protector 13a around single finger through single holing once the grip 12a is held manually, such as is illustrated in FIG. 13, the finger protector 13a, the grip 12a and the shell casing 11a being integrated integrally, or by combination, or by removable assemblage, the main feature of the invention, however, is that the shell casing 11a has its terminal edge formed in nearly trapezoidal cross section, such as is shown in FIG. 12, while the larger hypotenuse that is defined by two non-parallel inclusion angles is set flat to account for a laydown face 111a fit for setting righthandedly or lefthandedly, or the same is composed of a plurality of chosen distribution of layout points, or if preferred, a smaller layout plane, such as is illustrated in FIG. 14, and that on the remaining two sides or a larger side of these, on chosen locations of the shell casing 11a that is defined by a nearly trapezoidal cross section, are furnished control interfaces 112a, 113a, 114a meant for digital operation with the left hand or the right hand dependent upon the location of the device, to the left side or to the right side of the operator at reference point, such as is shown in FIG. 15 and FIG. 16, respectively, a top view of the device in service is given in FIG. 17, a lefthand application; a top view of the device in service pursuant to a righthand application, however, is given in FIG. 18.

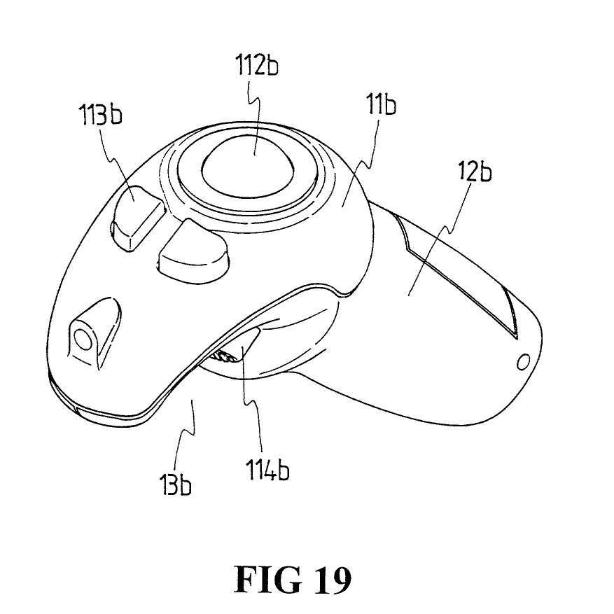

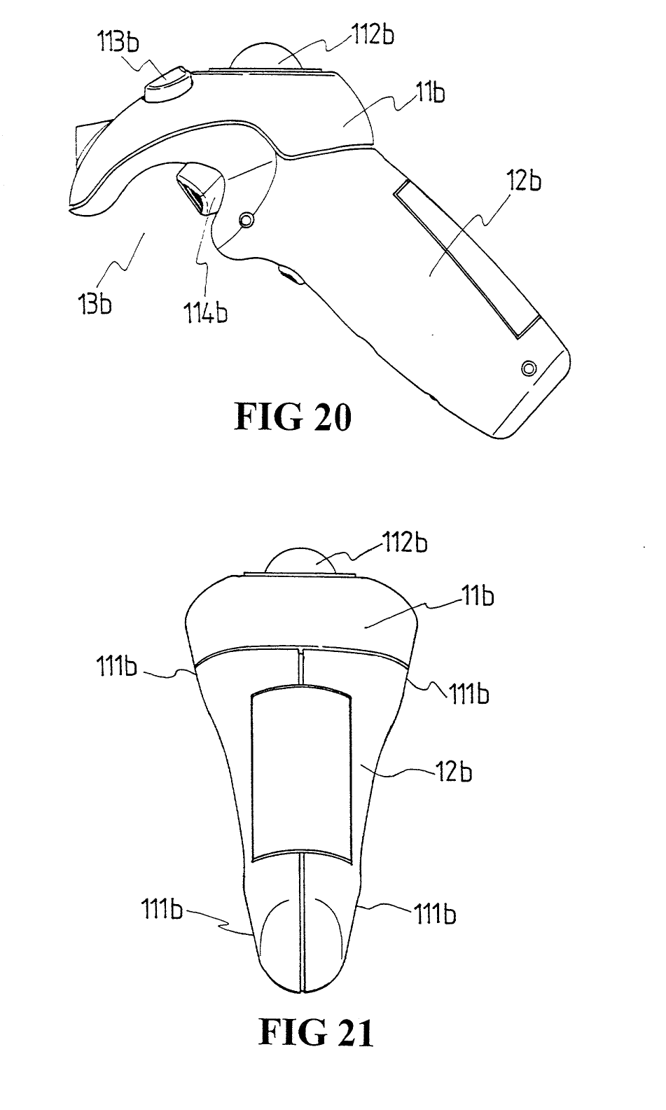

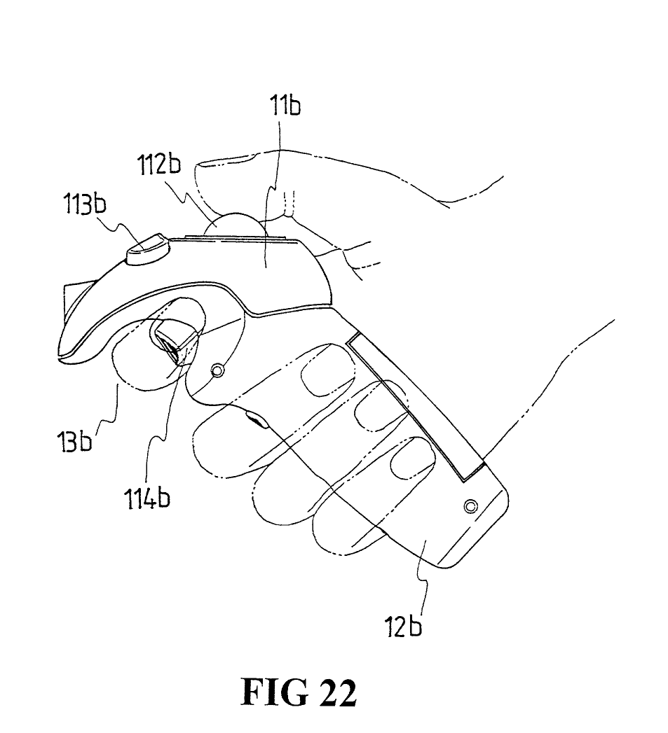

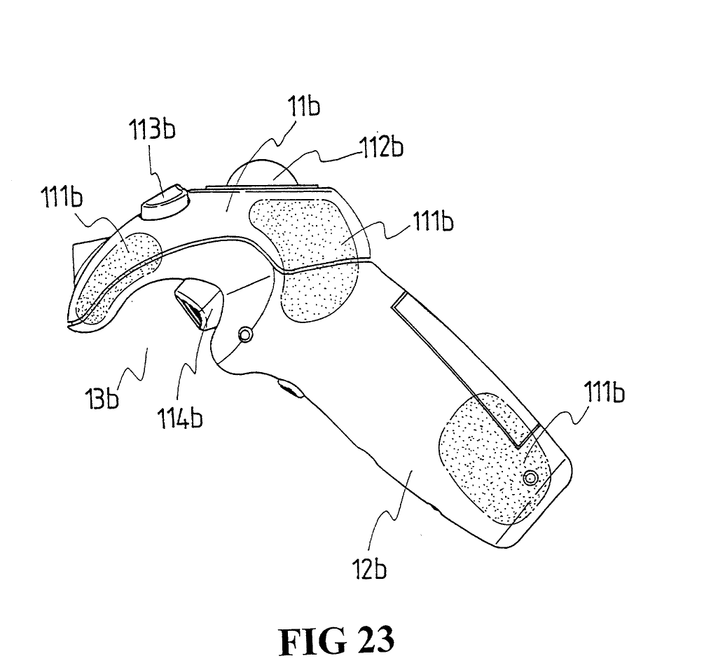

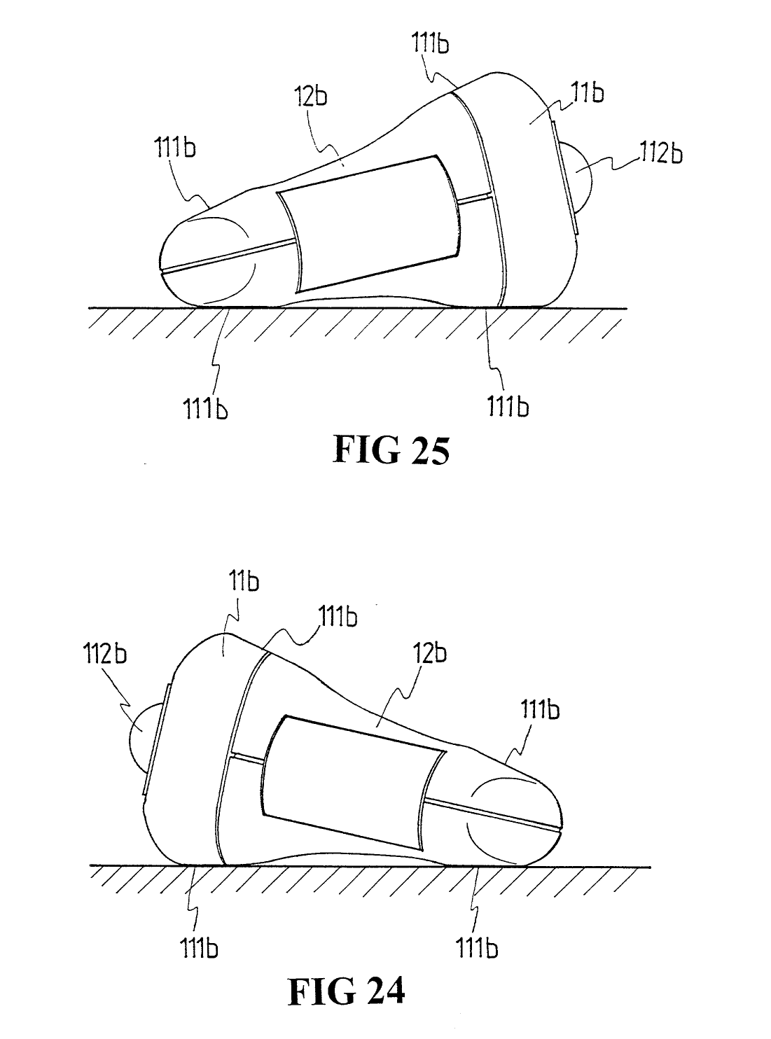

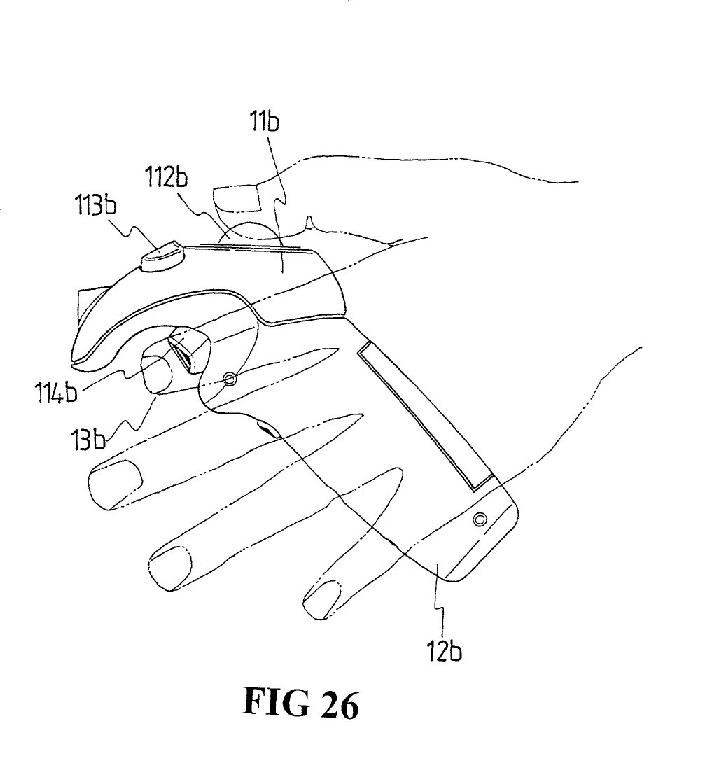

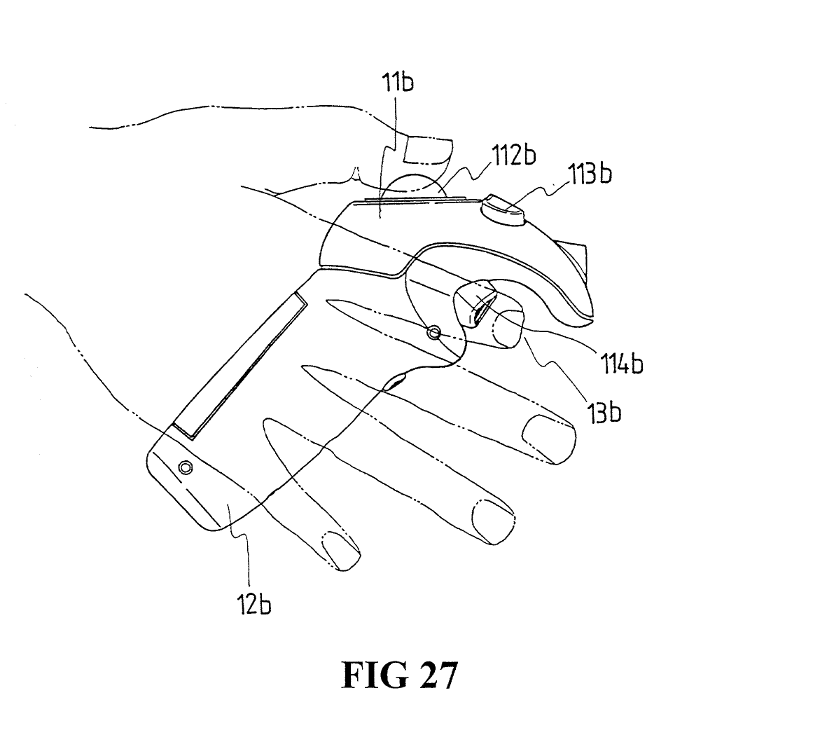

Referring to FIG. 19 and FIG. 20, a three-dimensional perspective of the invention embodied free of finger protector and a side view of same, comprising shell casing 11b into which are housed relevant circuits, power supply and manually controlled interfaces 112b, 113b, 114b and display interface, underneath the shell casing 11b is mounted a grip 12b for hand hold, ahead of same is optionally furnished an overt structure 13b free of finger protection, to facilitate holding of the grip 12b by naked finger duly bent, such as is shown in FIG. 22, note that the grip 12b and the shell casing 11b may be embodied integrally or by combination assemblage, or by removably designed assemblage; the salient feature of the invention, however, is having the terminal edge of the shell casing 11b configured nearly trapezoidal on the cross section, such as is shown in FIG. 20, and having the larger hypotenuse that is defined by two non-parallel inclusion angles treated in a flat plane or that formed instead by a plurality of chosen distribution of laying points or alternatively, by a yet smaller laying plane, to account for a laying face 111b good for layout on either side, right or left, such as is shown in FIG. 23, and having a control interface 112b, 113b, 114b, meant for digital operation, provided on the two remaining sides or a chosen location on the larger one of these, to facilitate operation by the right hand or by the left hand dependent upon the positioning of the device, righthanded or lefthanded of a reference point confronting the operator, such as is shown in FIG. 24 and FIG. 25, a top view of the device in service in a lefthand application is given in FIG. 26, a top view of the device in service in a righthand application is given in FIG. 27.

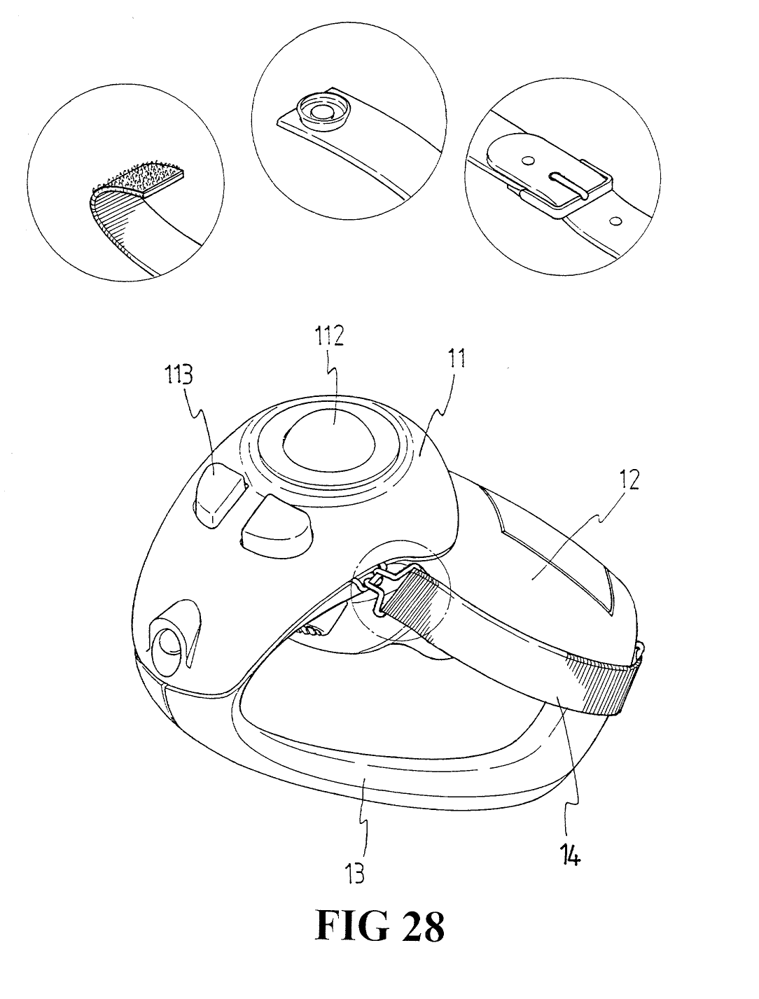

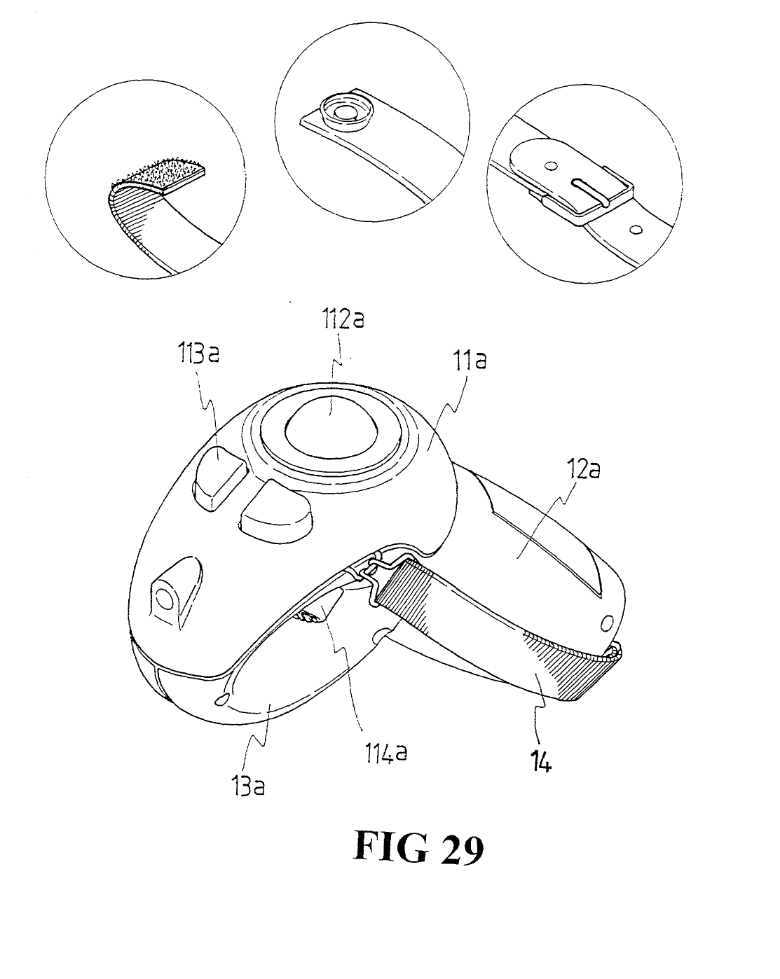

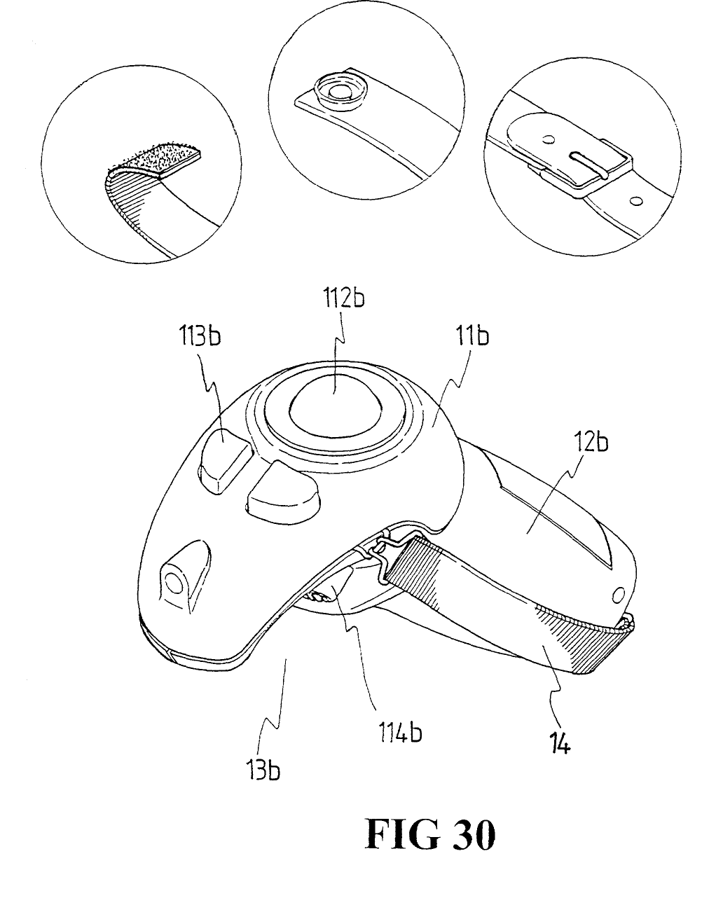

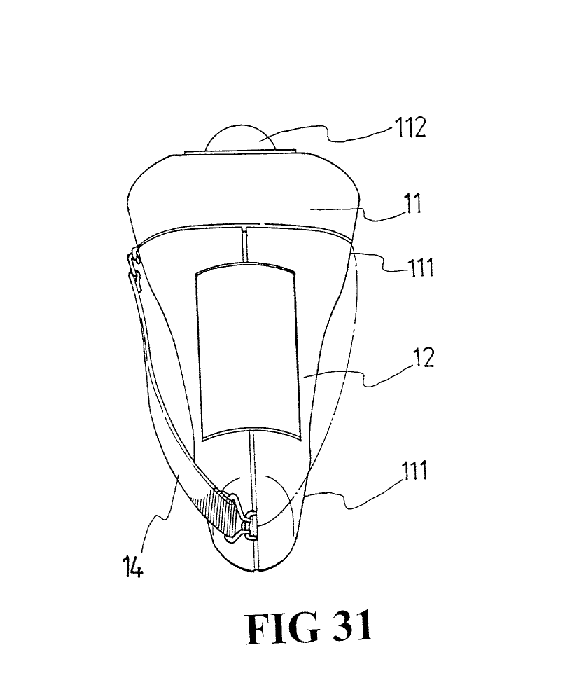

Considering the Control Device for Manual Hold by Either Hand, Disposable on Either Side, on the Tilt represented in FIG. 1 through FIG. 27 attached hereto, to prevent the Device from falling due to inadvertent operation, way between the shell casing and the grip, it is preferable to incorporate a adjunct snap ring thereto, such as is shown in the three-dimensional illustration given in FIG. 28 in view of the embodiments represented in FIG. 1 through FIG. 9; whereas FIG. 29 illustrates the adjunct snap ring fixture in a three-dimensional setting, for incorporation to an embodiment represented in FIG. 10 through FIG. 18; FIG. 30 illustrates, in a three-dimensional setting, the adjunct snap ring fixture that is good for incorporation to an embodiment represented in FIG. 19 through FIG. 27; FIG. 31 gives a side view of the embodiment that is illustrated in FIG. 28 through FIG. 30; the adjunct snap ring 14 being executed in a fixed assembly or in the form of an adjustable strap structure or of a resilient tension band, meant for installation on just one side or alternatively on either side, way between the shell casing and the grip, or still, executed in a single set of strap assembly, meant for installation on one of both or on one of more than two sides of the shell casing that is engaged by coupling with said set of strap assembly; said snap ring fixture being embodied in a hook configuration, or in a button structure, or in a self-bond fastener, or still in a belt ring, or alternatively in other assemblies bearing similar functions; such an adjunct snap ring fixture 14 is an optional feature.

A generalization of key features characterizing all the above mentioned embodiments is given below:

1) the geometry of both sides of the device is such that one of them, once lying pat to a bench surface, accounts for a stable face composed of multiple points or in a planar setting;

2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions;

3) An adjunct snap ring fixture 14 as an optional feature serves to prevent incidental fall of the Subject Control Device, and which is executed in a fixed assembly or in the form of an adjustable strap structure or of a resilient tension band, meant for installation on just one side or alternatively on either side, way between the shell casing and the grip, or still, executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in a belt ring, or alternatively in other assemblies bearing similar functional features.

In summation, this invention is intended as a design of Control Device for Manual Hold by Either Hand, Disposable on Either Side, on the Tilt, whereof aforementioned digitally controlled interface is processed, per functional requirements, into a rocker switch which is good for pushkeying actuation as well as cross shake operation, and that in turn in a mechanico-electrical structure comprising resistive, capacitive, photosensitive, pulsating, or encoded analogue or digital elements permissive of testing conducted involving mechanical displacements, or alternatively structured to permit digital control of sensitized, pressure bound, optic, rheostatic or capacitive sensors comprising the Device and allowing for stationary testing operations.

The disclosure going thus far should appear to parties skilled in the art that the invention, Control Device for Manual Hold by Either Hand, Disposable on Either Side, on the Tilt, is truly a worthy piece of invention, as would be judged as such by professionals duly enlightened.

I claim:

1. Control Device for Manual Hold by Either Hand, Disposable on Either Side, on the Tilt, whereof the shell casing resembles Trapezoidal across its section, with the larger hypotenuse that is defined by two inclusion angles out of parallelism with each other accounting for a laydown face, disposable rightward or leftward of a reference point; and with the remaining two sides or the larger one of these, of the shell casing, as aforementioned, accounting for a control interface meant for digital operation by manual hold, on either hand, as appropriate; structurally comprising:
having the afore-mentioned shell casing that is defined trapezoidal across its section configured in the form of a grip, and the grip furnished with a plurality of finger protection to accommodate hold by the hand for ready control, using a right hand should the Device happen to lie to the righthand side, or alternatively a left hand, should the Device happen to lie to the lefthand side, of the reference point; typically a bench top;
having the afore-mentioned shell casing that is defined trapezoidal across its section configured in the form of a grip, and the grip furnished with just one single finger ring protection to accommodate hold by the hand for ready control, using a right hand should the Device happen to lie to the righthand side, or alternatively a left hand, should the Device happen to the righthand side, of the reference point which is typically a bench top;
having the afore-mentioned shell casing that is defined trapezoidal across its section configured in a grip free of any protection ring for laying on top of a bench by either side to a reference point ready for right hand or left hand operation as appropriate.

2. Control Device for Manual Hold by Either Hand, Disposable on Either Side, on the Tilt, according to claim 1, comprising:
a shell framework accommodating analogous circuits, power supply, manually controlled interfacing and display interfacing;
handle in the form of a grip;
optionally provided annular protection means, surrounding the exteriority of singly formed or plurally formed finger, in single hole or multiple hole executions, once the grip is held manually; the annular protection being executed integral with the grip and the shell casing, or else by combination or still, removably; featuring a trapezoidal cross section, with the larger hypotenuse that is included by the angle formed by the non-parallel sides constituting the laydown side rightwards or leftwards of a reference table front, and the two remaining sides or the larger one of these, of the shell casing defined with a cross section accommodating a control interface meant for digital operation, say, by the right hand or left hand, as same is installed on the right-hand side or lefthand side of the reference table front;
Again, by setting said shell casing defined with a nearly trapezoidal cross section on a surface, with the larger hypotenuse that is included by two non-parallel laterals by which an angle is formed serving as the laydown side rightwards or leftwards of a reference table front, a flat surface spread, and the two remaining sides or the larger one of these, of the shell case as aforementioned defined with across section accommodating a control interface meant for digital operation, control for operation with the right hand or left hand is made depending on the location of the shell casing, on the right hand side or left hand side of the operator positioned in line with the reference point.

3. Control Device for Manual Hold by Either Hand, Disposable on Either Side, on the Tilt, according to claim 1, whereof the shell casing 11 houses relevant circuits, power supply and manually controlled interfacing 111, 112, 113, and display interface, underneath the shell casing 11 is mounted a grip 12 for manual hold, ahead of the grip 12 are furnished a plurality of digital indentations 121, and additionally where required, a digital protection means 13 around the multiple finger formation, so that once manual holding is made of the grip 12, same may be surrounded outside of the multiple finger formation through multiple holding array, the digital protection 13, the grip 12 and the shell casing 11 being executed integral, or for combination assemblage, or still, removably assembled; a salient feature of the invention is that the terminal edge of the shell casing 11 is treated nearly trapezoidal in the cross section, and that a larger hypotenuse defined by two inclusion angles out of parallelism on either side is made to account for a flat laydown surface 111, on the right hand side or on the left hand side, or alternatively, these be constituted of laying points of chosen deployment or still of yet smaller laying faces, further, on the two remaining sides or on the larger one of these, of the shell casing 11 that is defined with a trapezoidal cross section is installed where appropriate, control interfaces 112, 113, 114 so that once the device altogether is laid relatively righthanded or lefthanded of a table front, it will make handy control by the right hand or left hand respectively.

4. Control Device for Manual Hold by Either Hand, Disposable on Either Side, on the Tilt, according to claim 1, whereof the shell casing 1a houses relevant circuits, power supply and manually controlled interfacing 112a, 113a, 114a and display interface, underneath the shell casing 11a is installed a grip 12a for manual hold, ahead of the shell casing 11a is optionally furnished a finger protector 13a around single finger through single holing once the grip 12a is held manually, the finger protector 13a, the grip 12a and the shell casing 11a being integrated integrally, or by combination, or by removable assemblage, the main feature of the invention, however, is that the shell casing 11a has its terminal edge formed in nearly trapezoidal cross section, while the larger hypotenuse that is defined by two non-parallel inclusion angles is set flat to account for a laydown face 111a fit for setting righthandedly or lefthandedly, or the same is composed of a plurality of chosen distribution of layout points, or if preferred, a smaller layout plane, and that on the remaining two sides or a larger side of these, on chosen locations of the shell casing 11a that is defined by a nearly trapezoidal cross section, are furnished control interfaces 112a, 113a, 114a meant for digital operation with the left hand or the right hand dependent upon the location of the device, to the left side or to the right side of the operator at reference point respectively.

5. Control Device for Manual Hold by Either Hand, Disposable on Either Side, on the Tilt, according to claim 1, whereof the shell casing 11b houses relevant circuits, power supply and manually controlled interfaces 112b, 113b, 114b and display interface, underneath the shell casing 11b is mounted a grip 12b for hand hold, ahead of same is optionally furnished an overt structure 13b free of finger protection, to facilitate holding of the grip 12b by naked finger duly bent, note that the grip 12b and the shell casing 11b may be embodied integrally or by combination assemblage, or by removably designed assemblage; the salient feature of the invention, however, is having the terminal edge of the shell casing 11b configured nearly trapezoidal on the cross section, and having the larger hypotenuse that is defined by two non-parallel inclusion angles treated in a flat plane or that formed instead by a plurality of chosen distribution of laying points or alternatively, by a yet smaller laying plane, to account for a laying face 11b good for layout on either side, right or left, and having a control interface 112b, 113b, 114b, meant for digital operation, provided on the two remaining sides or a chosen location on the larger one of these, to facilitate operation by the right hand or by the left hand dependent upon the positioning of the device, righthanded or lefthanded of a reference point confronting the operator.

6. Control Device for Manual Hold by Either Hand, Disposable on Either Side, on the Tilt, according to claim 1, characteristically comprising:
1) the geometry of both sides of the device is such that one of them, once lying pat to a bench surface, accounts for a stable face composed of multiple points or in a planar setting;
2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions.

7. Control Device for Manual Hold by Either Hand, Disposable on Either Side, on the Tilt, according to claim 2, characteristically comprising:
1) the geometry of both sides of the device is such that one of them, once lying pat to a bench surface, accounts for a stable face composed of multiple points or in a planar setting;
2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions.

8. Control Device for Manual Hold by Either Hand, Disposable on Either Side, on the Tilt, according to claim 3, characteristically comprising:
1) the geometry of both sides of the device is such that one of them, once lying pat to a bench surface, accounts for a stable face composed of multiple points or in a planar setting;
2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions.

9. Control Device for Manual Hold by Either Hand, Disposable on Either Side, on the Tilt, according to claim 4, characteristically comprising:
1) the geometry of both sides of the device is such that one of them, once lying pat to a bench surface, accounts for a stable face composed of multiple points or in a planar setting;
2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions.

10. Control Device for Manual Hold by Either Hand, Disposable on Either Side, on the Tilt, according to claim 5, characteristically comprising:
1) the geometry of both sides of the device is such that one of them, once lying pat to a bench surface, accounts for a stable face composed of multiple points or in a planar setting;
2) the device, once laid firm to a bench surface, regardless of orientation, rightward or leftward, will tolerate casual oppression by the hand palm thereon, and that followed by intentional manipulation by fingers on either hand, of the control interface mounted on the larger base of the trapezoidal cross section of the shell casing, the control interface comprising singly or plurally, compoundly: means to produce digital or analogue signals, cross switches, photosensitizer, capacitive sensor, rheostat, plus display, and additionally optional interfacing units such as, for example, (1) switches, (2) display lamps, (3) speaker, (4) timer, (5) counter, and one or more of these units may be made to interact with digital or analogue signals produced at the digitally controlled interface and the display, whereas internally the device comprises power supply, battery cell, for example, electric, electronic circuits, radio transmission circuits, radio receiver circuits, or associated functional software circuits, to work in coordination with digital or analogue signals produced at digitally controlled interface compartments, the display is an optional item, and all these serving to get the invention, a Control Device for Manual Hold by Either Hand, Disposable on Either Side, on the Tilt at work, to discharge its intended functions.

11. Control Device for Manual Hold by Either Hand, Disposable on Either Side, on the Tilt, according to claim 1, which further incorporates an adjunct snap ring fixture to prevent incidental fall of same Device way between the shell casing and the grip, such an adjunct snap ring fixture 14 is executed in a fixed assembly or in the form of an adjustable strap structure or of a resilient tension band, meant for installation on just one side or alternatively on either side, way between the shell casing and the grip, or still executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in an annular belt, or alternatively in other assemblies bearing similar functional features; and this as an optional item 14.

12. Control Device for Manual Hold by Either Hand, Disposable on Either Side, on the Tilt, according to claim 2, which further incorporates an adjunct snap ring fixture to prevent incidental fall of same Device way between the shell casing and the grip, such an adjunct snap ring fixture 14 is executed in a fixed assembly or in the form of an adjustable strap structure or of a resilient tension band, meant for installation on just one side or alternatively on either side, way between the shell casing and the grip, or still executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in an annular belt, or alternatively in other assemblies bearing similar functional features; and this as an optional item 14.

13. Control Device for Manual Hold by Either Hand, Disposable on Either Side, on the Tilt, according to claim 3, which further incorporates an adjunct snap ring fixture to prevent incidental fall of same Device way between the shell casing and the grip, such an adjunct snap ring fixture 14 is executed in a fixed assembly or in the form of an adjustable strap structure or of a resilient tension band, meant for installation on just one side or alternatively on either side, way between the shell casing and the grip, or still executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in an annular belt, or alternatively in other assemblies bearing similar functional features; and this as an optional item 14.

14. Control Device for Manual Hold by Either Hand, Disposable on Either Side, on the Tilt, according to claim 4, which further incorporates an adjunct snap ring fixture to prevent incidental fall of same Device way between the shell casing and the grip, such an adjunct snap ring fixture 14 is executed in a fixed assembly or in the form of an adjustable strap structure or of a resilient tension band, meant for installation on just one side or alternatively on either side, way between the shell casing and the grip, or still executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in an annular belt, or alternatively in other assemblies bearing similar functional features; and this as an optional item 14.

15. Control Device for Manual Hold by Either Hand, Disposable on Either Side, on the Tilt, according to claim 5, which further incorporates an adjunct snap ring fixture to prevent incidental fall of same Device way between the shell casing and the grip, such an adjunct snap ring fixture 14 is executed in a fixed assembly or in the form of an adjustable strap structure or of a resilient tension band, meant for installation on just one side or alternatively on either side, way between the shell casing and the grip, or still executed in a single set of strap assembly, meant for installation on one of both or on one of more than two sides of the shell casing that is engaged by coupling to said set of strap assembly; said snap ring fixture being embodied in a hook configuration, or in a button structure, or in a self-bond fastener, or still in an annular belt, or alternatively in other assemblies bearing similar functional features; and this as an optional item 14.

16. Control Device for Manual Hold by Either Hand, Disposable on Either Side, on the Tilt, according to claim 1, whereof the digitally controlled interface is processed, per functional requirements, into a rocker switch which is good for pushkeying actuation as well as cross shake operation, and that in turn in a mechanico-electrical structure comprising resistive, capacitive, photosensitive, pulsating, or encoded analogue or digital elements permissive of testing conducted involving mechanical displacements, or alternatively structured to permit digital control of sensitized, pressure bound, optic, rheostatic or capacitive sensors comprising the Device and allowing for stationary testing operations.
